(19) United States
(12) Patent Application Publication
(10) Pub. No.: US 2011/0186563 A1
(43) Pub. Date: Aug. 4, 2011

(54) ELECTRIC HEATER WITH OMEGA TUBE

(76) Inventor: Andreas SCHLIPF, Tuttlingen (DE)

(21) Appl. No.: 13/016,097

(22) Filed: Jan. 28, 2011

(30) Foreign Application Priority Data
Jan. 29, 2010 (DE) 202010001573.1

(51) Int. Cl. H05B 3/40; B23P 19/04

(52) U.S. Cl. 219/534; 29/428

(57) ABSTRACT

An electric heater (10), especially for heating surfaces of components, over which the electric heater (10) is pushed or on which it is placed, is provided with an inner jacket (21) and an outer jacket (22), which form a double-walled tube, wherein said double-walled tube (20) has a recess (24), which passes completely through the inner jacket (21) and the outer jacket (22), in the direction in which the electric heater (10) extends, and which is delimited by wall surfaces (25, 26) from the space (23) between the inner jacket (21) and outer jacket (22). The heater (10) has at least one tubular heating element (11), which has a metal jacket, and which is arranged in the space (23) between the inner jacket (21) and outer jacket (22). The inner jacket (21), the outer jacket (22) and the wall surfaces (25, 26) are contiguous and are formed of a single piece of material. A process for manufacturing an electric heater is provided including either the steps of inserting a tubular electric heating element into a provided section of a metal strip, whose side edges are connected to one another, and joint shaping of at least the heating element and metal strip into a double-walled tube with a recess passing through the inner jacket and outer jacket of the double-walled tube or the steps of providing a double-walled tube with an inner jacket and an outer jacket, which has a recess, which passes completely through the inner jacket and the outer jacket, in the direction in which the electric heater extends, and which is delimited by wall surfaces from the space between the inner jacket and outer jacket and in which the inner jacket, the outer jacket and the wall surfaces are formed from a single piece of material, and inserting the tubular heating element into an insertion opening provided on the front side of the double-walled tube.

### CROSS REFERENCE TO RELATED APPLICATIONS

This application claims the benefit of priority under 35 U.S.C. §119 of German Utility Model 20 2010 001 573.1 filed Jan. 29, 2010, the entire contents of which are incorporated herein by reference.

### FIELD OF THE INVENTION

The present invention pertains to an electric heater with an inner jacket and an outer jacket, which form a double-walled tube having a recess, which passes completely through the inner jacket and the outer jacket in the direction in which the electric heater extends, and which is delimited by wall surfaces from the space between the inner jacket and outer jacket and with a tubular heating element arranged in the space between the inner jacket and the outer jacket. Such heaters are used, for example, to heat tools, machine parts and apparatuses, especially plastic injection nozzles. However, their use is not limited to this purpose; it is possible, for example, to bring fluids to a desired temperature by passing them through this kind of heater. As an alternative, stagnant fluids or expanding wax can also be brought to a desired temperature.

### BACKGROUND OF THE INVENTION

Especially popular embodiments of such heaters are those with a cylindrical geometry. Heaters with a cylindrical geometry are known, for example, from DE 201 09 413 U1, EP 1 395 085 B1 or DE 103 33 206 B4.

The prior-art electric heaters comprise, as a rule, two boundary surfaces, especially tubes, which are arranged at spaced locations from one another and between which a usually tubular heating element, which comprises the heat conductor proper, is arranged. There are forms of construction in which the tubes are provided with a recess extending through them in the direction of extension thereof in order to create the possibility of clamping the heater onto the component to be heated, in which the tubes must be connected to one another by wall surfaces. However, this is associated with a great manufacturing effort.

### SUMMARY OF THE INVENTION

The object of the present invention is therefore to make available an electric heater with good heating properties, which can be manufactured in a favorable manner.

The electric heater according to the present invention, which is especially suitable for heating surfaces of components, over which the electric heater is pushed or on which said electric heater is placed, has an inner jacket and an outer jacket, which form a double-walled tube, wherein said double-walled tube has a recess, which passes completely through the inner jacket and outer jacket in the direction in which the electric heater extends and which is delimited by wall surfaces from the space between the inner jacket and outer jacket. Furthermore, it has at least one tubular heating element, which has a metal jacket and which is arranged in the space between the inner jacket and outer jacket. The heater is characterized according to the present invention in that the inner jacket, outer jacket and wall surface are contiguous and consist of a single piece of material. Contiguous means here that during an imaginary motion on the respective jacket or wall surface tangentially to the edge of a cut surface through the tube, one arrives again at the starting point from a starting point especially at least in case of a cross-sectional area.

Thus, the present invention is based on the basic discovery that it is possible to prepare the complex, double-walled structure with a recess passing through same from a single piece of material and to nevertheless guarantee the possibility of arranging at least the tubular heating element in the tube between the inner jacket and outer jacket. Additional operations can be eliminated as a result during the manufacture of the heater, which lowers the costs.

A tube in the sense of this invention does not consequently have to have a breach-free jacket surface; in particular, the term tube is used for the structure with a recess, e.g., a slot or gap, which passes through the jacket surface in the axial direction over the entire length thereof, i.e., the structure can be prepared, e.g., by impressing a constant curvature onto a metal strip, as long as a space is formed as a result, which is essentially enclosed by the inner jacket surface and which is perforated by the recess, in particular, over a small angle range of the tube cross section, equaling, e.g., 10° or less. A corresponding double-walled tube can be manufactured, for example, by impressing a curvature onto a metal strip, whose side edges are connected to one another. A restriction concerning the cross section of the tube also cannot be derived from this term; in particular, this cross section may be not only round but also elliptical, angular or polygonal. This also covers a variation in cross section and especially diameter, so that a conically tapering tube can also be covered by the generic term “tube.”

In an embodiment of the electric heater that is especially preferred from the viewpoint of the most symmetrical heating possible of the component to be heated, the wall surfaces are curved towards the recess. In other words, these boundary surfaces are convex when viewed from the recess. The area of the component to be heated that remains completely unheated can be kept as small as possible in this embodiment.

An embodiment of the present invention, which is optimized concerning the number of operations necessary for manufacturing the electric heater, is obtained if the double-walled tube formed by the inner jacket, outer jacket and wall surfaces is a drawn tube. As a rule, a preferably round starting tube is drawn over drawing tools into the shape of an Omega. Depending on the complexity of the geometry and the problems associated therewith in manufacture, it may, however, also be meaningful in exceptional cases to prepare the double-walled tube formed by the inner jacket, outer jacket and wall surfaces as a welded tube, i.e., to form the structures from a sheet metal such that two edges of the sheet metal are located opposite each other, and to weld these then together.

It is especially favorable if the double-walled tube has an insertion opening on the front side, through which the tubular heating element, arranged individually and/or at a carrier, can be inserted into the space between the inner jacket and outer jacket. It becomes possible as a result to insert the heating element into the finished double-walled tube, which makes possible a higher level of modularization of manufacture. It is, of course, also possible, in principle to form the tubular heating element together with a precursor component into the double-walled tube, e.g., to form the sheet metal around the tubular heating element when welded tubes are used.

The embedding of the tubular heating element in a powder or in a granular material offers considerable advantages. Neither is it necessary to prepare a groove in a plate, nor is it necessary to apply such a high pressure that an extensive impression of the tubular heating element takes place, and a casting process is avoided altogether. Furthermore, a higher degree of homogeneity of the thermal contact between the heating element and the environment is automatically reached due to the use of a powder. Especially good results can be surprisingly obtained with the use of granular materials. Granular materials differ from powders by their coarser structure, which is manifested by larger granules, and they can be prepared especially by grain coarsening processes from powders. Granular metal products, whose extension in any desired direction of space leads to a mean particle size between 0.03 mm and 1 mm, are especially preferred.

The powder or granular material may consist, for example, of a metal, especially aluminum, brass or copper, but also a metal oxide, a quartz sand or a ceramic compound. It is especially advantageous if the double-walled tube and the powder or granular material consist of the same material.

To guarantee an especially good heat transfer within the electric heater, it is meaningful if the electric heater is completely or partly compacted.

The geometric embodiment of the electric heater is advantageously adapted to the geometry of the component to be heated. It may provide, in particular, a space with radial symmetry surrounded by the inner jacket and the recess in the inner jacket or be radially symmetrical as a whole. It is also possible in this embodiment to heat conical components. However, it may also be useful if the space surrounded by the inner jacket and the recess in the inner jacket or the entire heater is cylindrical or if the space surrounded by the inner jacket and the recess in the inner jacket or the entire heater has an oval, bent, angular or elliptical geometry.

Depending on the use, it may, furthermore, be advantageous to protect the space between the inner jacket and outer jacket of the double-walled tube against environmental effects by said space being surrounded by limiting surfaces on all sides. In particular, a one-part or multi-part frame made of metal, mica, plastic or ceramic, which defines the space filled with the at least one powder or granular material in the directions in which the at least two defining surfaces extend, may be used for this. In the simple case of an arrangement formed from two tubes, this is formed simply by two disks or rings. However, it is also possible, for example, to achieve such a limitation in space by a closure with the use of a casting compound, especially silicone rubber, epoxy resin or a ceramic compound.

Finally, it is advantageous for some applications if the electric heater is filled with a plurality of different metal powders, especially with a plurality of different metal powders, which are arranged in different chambers of the electric heater. Such chambers can be prepared, for example, by providing partitions between the outer and inner jackets.

The temperature profile obtained can be further varied by providing a plurality of tubular heating elements.

Especially preferred dimensions of the inner metal tube are present if an inner contour of the inner metal tube has smaller dimensions than the component to be heated and can thus be clamped onto same. It is also useful, as an alternative, to arrange clamping elements, with which the heater can be clamped onto the component to be heated, on the outer metal tube.

If, moreover, a jacket thermometer or a thermocouple is passed through the recess, the thermometer can be replaced simply and at a low cost in case of its failure. As an alternative, the jacket thermometer or thermocouple may also be arranged in the space between the inner jacket and outer jacket. Detachability can be achieved in this embodiment for the jacket thermometer or thermocouple, for example, by it being guided in a guide tube arranged in the space between the inner jacket and outer jacket.

It is especially advantageous if the electric heater has at least one fixing element, which fixes the relative positions of different sections of the tubular heating element, especially of meanders formed by the tubular heating element, in relation to one another. It is ensured in this embodiment that any mechanical stresses of the tubular heating element, which occur during the assembly or operation of the electric heater, cannot change the geometric course thereof, especially in terms of the length of the tubular heating element, as a result of which the desired heat distribution can be achieved for a reliable process.

In an especially simple embodiment, the fixing element is designed as a comb or wire. A comb is defined especially as a strip of material, which has a number of recesses along its longitudinal extension, which pass through the strip of material at right angles or obliquely to the direction of extension thereof and fix the tubular heating element, when it is received therein, in this direction.

However, it may also be advantageous, for example, if a special stability of the electric heater is desired, if the fixing element is a tube with a recess passing through the tube, which said recess corresponds to the shape of the tubular heating element.

A procedure that is especially advantageous concerning the installation space needed is to design the fixing element as a flute or groove prepared in the inner jacket or in the outer jacket, if this is opened in the direction of the space that is located between the inner jacket and outer jacket.

It is advantageous, furthermore, if an inner metal tube, outer metal tube, bottom disk or connection-side end disk are manufactured from a prestressed material, especially prestressed spring steel. A high clamping pressure can be exerted hereby on a component to be heated.

In an especially preferred, especially cost-effective process according to the present invention, a double-walled tube with an inner jacket and an outer jacket, which has a recess passing completely through the inner jacket and outer jacket in the direction of extension of the electric heater and which recess is delimited by wall surfaces from the space between the inner jacket and outer jacket, and in which said tube the inner jacket, outer jacket and wall surfaces are formed from a single piece of material, is made available at first, and the tubular heating element is then inserted into an insertion opening provided on the front side of the double-walled tube. An Omega tube shaped to a finished or nearly finished state may now be made available as cut goods and cut to the desired length. The tubular electric heating element adapted to the cavity of the Omega tube can then be inserted into the Omega tube adapted to the target shape of the electric heater.

An alternative process for manufacturing electric heaters according to the present invention comprises the inserting of a tubular electric heating element into a provided section of a metal strip, whose side edges are connected to one another, and the subsequent shaping of at least the heating element and metal strip together into a double-walled tube with a recess passing through the inner jacket and outer jacket of the double-walled tube.

The tubular heating element may be embedded in a powder or granular material in both processes; this may happen prior to the shaping in the first process, and alternatively after the shaping in both processes. A connection extending essentially at right angles to the direction of extension of the heater can be established, especially by a bottom disk, between the inner jacket and outer jacket or between the surfaces that form the inner jacket and outer jacket after the shaping. The volume left after the insertion of the tubular heating element between the inner jacket and outer jacket or between the surfaces that form the inner jacket and outer jacket after the shaping is then filled, preferably while shaking, with the powder or granular material.

The tubular heating element can be arranged at first at a carrier element prior to insertion in both processes alike. However, the alternative process is especially well suited for such carrier-type tubular heating elements, because the need to also shape the carrier element can be avoided in this procedure, which reduces the necessary expenditure of force and avoids the risk of damage to the tubular heating element and carrier element.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1a is a sectional view of an electric heater according to an exemplary embodiment of the present invention, cut at right angles to the direction in which the electric heater extends; and

FIG. 1b is an exploded view of the electric heater from Figure la.

### DESCRIPTION OF THE PREFERRED EMBODIMENTS

Referring to the drawings in particular, identical reference numbers are used in all figures for identical components of identical exemplary embodiments.

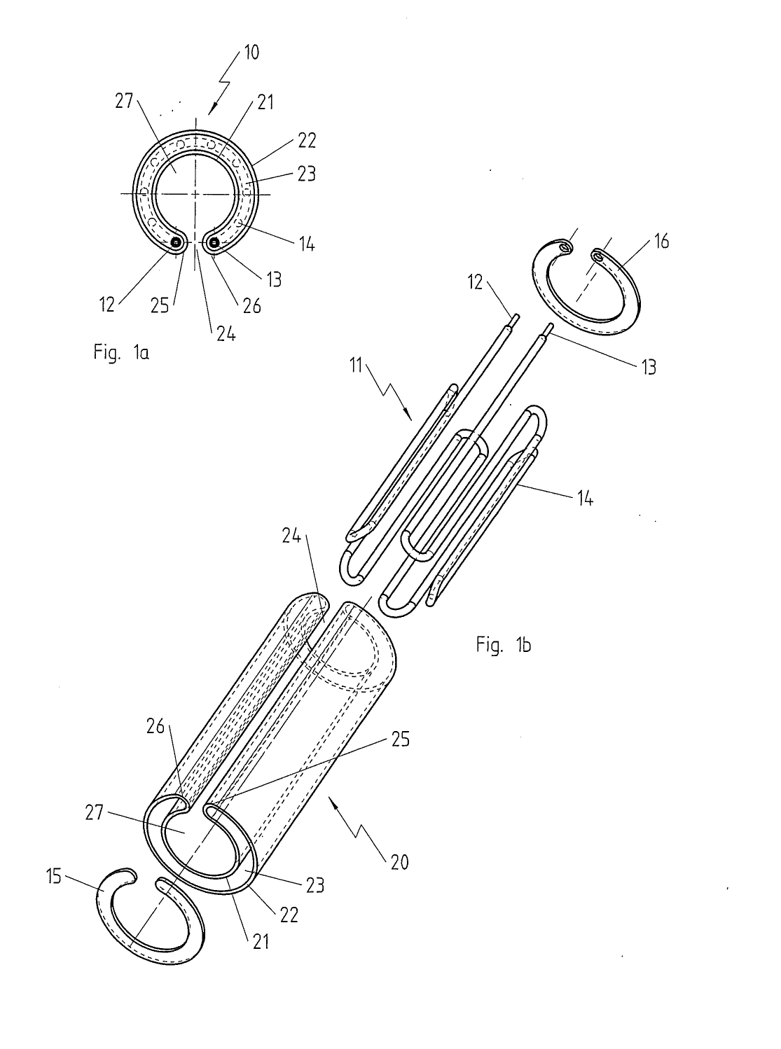

FIG. 1a shows a sectional view of an electric heater according to an exemplary embodiment of the present invention, cut at right angles to the direction in which the electric heater extends. The electric heater 10 has a double-walled tube 20 with an inner jacket 21 and an outer jacket 22, which define a space 23 between them. The inner jacket 21 and outer jacket 22 are arranged radially symmetrically and concentrically with one another in relation to the section shown, but other geometries are possible. A recess 24 passes through the inner jacket 21 and outer jacket 22. Space 23 is separated from the recess by wall surfaces 25, 26, which are curved in FIG. 1a in the direction of recess 24. The inner jacket 21 and the part of the recess that passes through the inner jacket 21 surround space 27, in which, e.g., the component to be heated can be mounted.

Furthermore, the ends 12, 13 of a tubular heating element 11 are seen, which said heating element is arranged, as can be clearly recognized from FIG. 1b, in space 23 in a meanderingly bent manner. Besides the ends 12, 13 of the tubular heating element 11, the other windings 14 of the heating element 11 are shown in FIG. 1a. The tubular heating element may be arranged in a carrier, not shown. Furthermore, a powder or granular material, not shown, may be arranged in space 23.

FIG. 1b shows an exploded view of the electric heater 10 from FIG. 1a, from which it appears especially clearly that the arrangement according to the present invention can be assembled by simply inserting the parts into one another. In addition to the components already described on the basis of FIG. 1a, a connection-side end disk 15 and a bottom-side end disk 16 are shown, with which space 23 can be closed.

While specific embodiments of the invention have been shown and described in detail to illustrate the application of the principles of the invention, it will be understood that the invention may be embodied otherwise without departing from such principles.

### LIST OF REFERENCE NUMBERS

10 Electric heater
11 Tubular heating element
12, 13 Ends of the tubular heating element
14 Winding of the tubular heating element
15 Bottom-side end disk
16 Connection-side end disk
20 Double-walled tube
21 Inner jacket
22 Outer jacket
23 Space
24 Recess
25, 26 Wall surface
27 Space

What is claimed is:

1. An electric heater for heating surfaces of components, over which the electric heater can be pushed or on which it can be placed, the electric heater comprising:
an inner jacket and an outer jacket which form a double-walled tube with a recess, the recess passing completely through the inner jacket and through the outer jacket and the recess extending in a direction in which the electric heater extends, the recess being delimited by wall surfaces from the space between the inner jacket and the outer jacket; and
at least one tubular heating element with a metal jacket, the tubular heating element being arranged in the space between the inner jacket and the outer jacket, the inner jacket and the outer jacket and the wall surfaces being contiguous and being formed of a single piece of material.

2. An electric heater in accordance with claim 1, wherein the wall surfaces are curved in the direction of the recess.

3. An electric heater in accordance with claim 1, wherein the double-walled tube formed by the inner jacket, the outer jacket and wall surfaces is a drawn tube.

4. An electric heater in accordance with claim 1, wherein the double-walled tube formed by the inner jacket, the outer jacket and the wall surfaces is a welded tube.

5. An electric heater in accordance with claim 1, wherein the double-walled tube has an insertion opening on a front side, through which the tubular heating element, arranged individually and/or at a carrier, is inserted into the space between the inner jacket and the outer jacket.

6. An electric heater in accordance with claim 1, wherein the tubular heating element comprises a bent or meandering compacted tube coil cartridge or a bent or meandering tubular heating body.

7. An electric heater in accordance with claim 1, wherein the space between the inner jacket and the outer jacket of the double-walled tube is filled with a powder or granular material.

8. An electric heater in accordance with claim 1, wherein the electric heater is completely or partly compacted.

9. An electric heater in accordance with claim 7, wherein the double-walled tube and the powder or granular material consist of the same material.

10. An electric heater in accordance with claim 1, wherein the electric heater is filled with a plurality of different metal powders, which are arranged in different chambers of the electric heater.

11. An electric heater in accordance with claim 1, further comprising at least one fixing element, which fixes the relative positions of different sections of the tubular heating element in relation to one another.

12. An electric heater in accordance with claim 11, wherein the at least one fixing element comprises a comb or wire.

13. An electric heater in accordance with claim 11, wherein the at least one fixing element is a tube adapted to the shape of the double-walled tube with a recess, which passes through the tube and corresponds to the shape of the tubular heating element.

14. An electric heater in accordance with claim 11, wherein the fixing element is formed by a flute or groove, which is prepared in the inner jacket or in the outer jacket and which is opened in the direction of the space between the inner jacket and outer jacket.

15. An electric heater in accordance with claim 1, further comprising at least one of a bottom-side end disk and a connection-side end disk, wherein the double-walled tube or the bottom-side end disk or the connection-side end disk are formed of a prestressed spring steel.

16. An electric heater in accordance with claim 1, further comprising at least one of a bottom-side end disk and a connection-side end disk, wherein the double-walled tube and/or a bottom-side end disk and/or a connection-side end disk are formed of a material with a coefficient of thermal expansion that is lower than that of the component to be heated.

17. An electric heater in accordance with claim 1, wherein the double-walled tube with the outer jacket, the inner jacket and the wall surfaces is made available in the finished or nearly finished state and the double-walled tube adapted to the target shape of the electric heater is inserted into the tubular electric heating element.

18. A process for manufacturing an electric heater, the process comprising the steps of:
inserting a tubular electric heating element into a provided section of a metal strip, whose side edges are connected to one another; and
joint shaping at least of the heating element and of the metal strip into a double-walled tube with a recess passing completely through the inner jacket and through the outer jacket and the recess extending in a direction in which the electric heater extends, the recess being delimited by wall surfaces from the space between the inner jacket and the outer jacket.

19. A process for manufacturing an electric heater, the process comprising the steps of:
providing a double-walled tube with an inner jacket and an outer jacket, which said tube has a recess, which passes completely through the inner jacket and outer jacket in the direction in which the electric heater extends, and which is delimited by wall surfaces from the space between the inner jacket and outer jacket and in which the inner jacket, the outer jacket and the wall surfaces are formed from a single piece of material; and
inserting the tubular heating element into an insertion opening provided on the front side on the double-walled tube.
